(19) United States
(12) Patent Application Publication
(10) Pub. No.: US 2013/0090858 A1
(43) Pub. Date: Apr. 11, 2013

(54) SYSTEM FOR MEASURING COSEISMIC MOVEMENTS OR VIBRATIONS OF STRUCTURES BASED ON GLOBAL NAVIGATION SATELLITE SYSTEMS-GNSS AND/OR PSEUDOLITES

(71) Applicants: Mattia Giovanni Crespi, Roma (IT); Augusto Mazzoni, Roma (IT); Gabriele Colosimo, Roma (IT)

(72) Inventors: Mattia Giovanni Crespi, Roma (IT); Augusto Mazzoni, Roma (IT); Gabriele Colosimo, Roma (IT)

(73) Assignee: Universita' degli Studi di Roma 'La Sapienza', Roma (IT)

(21) Appl. No.: 13/704,325

(22) PCT Filed: Jun. 14, 2011
(86) PCT No.: PCT/EP2011/059798

§ 371 Date: Dec. 14, 2012

(30) Foreign Application Priority Data
Jun. 14, 2010 (IT) RM2010A000323

(51) Int. Cl. G01V 1/28

(52) U.S. Cl. CPC G01V 1/282
USPC 702/14

(57) ABSTRACT

System for measuring coseismic movements or vibrations of structures based on measurements of phase observations performed on at least four sources simultaneously, between GNSS satellites and/or pseudolites, for couples of consecutive timepoints (t,t+1) temporally separated by not more than one second.

### FIELD OF THE INVENTION

The present invention relates to a system for measuring movements, operating in real time and a posteriori (post-processing), with precision with centimetre order of magnitude, in particular for coseismic movements or vibrations of structures based on Global Navigation Satellite Systems-GNSS and/or pseudolites.

### PRIOR ART

Among the Global Navigation Satellite Systems-GNSS (GPS, GLONASS, GALILEO, Compass-Beidou), GPS and, partly, GLONASS are often used in the area of monitoring coseismic displacements due to earthquakes and displacements associated with the modes of vibration of large structures such as bridges, skyscrapers and towers. For the measurements to be of any value, it is necessary to be able to detect displacements of the order of a centimetre.

The measurement data acquired by GPS and GLONASS receivers (phase observations) are characterized by the presence of multiple effects/disturbances connected with varied physical phenomena, the most important of which are: errors of the clocks (both of the satellites and of the receiver), tropospheric and ionospheric refraction and multiple paths (multipath). All these effects are difficult to model. The ephemerides of the satellites (all of the parameters necessary for calculating the orbits), corrections for the errors of the clocks of the satellites and a global ionospheric model for correcting for ionospheric refraction, can be known in real time, i.e. broadcast by radio, but with insufficient accuracy for applications in which the displacements being measured are calculated from the difference in absolute positions. Accordingly it is essentially impossible to achieve the aforementioned centimetre precision.

These correction data can be available in an accurate form, but with a time delay that does not permit measurements in real time.

For minimizing the effects of these physical phenomena, the prior art offers two possible solutions.

A first solution relates to the so-called double-difference method, based on reception of signals (phase observations) emitted from two satellites and received by two receivers not more than a few hundred kilometres apart. In particular, each double difference is defined as the difference between first differences relating to different satellites, each first difference being defined as the difference between the signals received (phase observations) from the two receivers and coming from the same satellite. In a dual-frequency receiver, both the first differences and the double differences are formed for all the frequencies acquired or for combinations thereof.

The double-difference method is useful for estimating differences of position of a receiver closer to an epicentre of the earthquake relative to at least one other receiver, sufficiently distant from the epicentre of the earthquake, the position of which is assumed to be known.

The double-difference method requires knowing the positions of the satellites by means of the ephemerides at least of the broadcast type (acquired in real time by any GNSS receiver) or by means of accurate correction data: precise ephemerides and, at the same time, permits elimination of the ionospheric disturbance by using and combining two observation signals according to two different frequencies of transmission/reception, significant attenuation of the tropospheric disturbance by means of the modelling and double differentiation and elimination of the effect of the errors of the clocks (of satellites and receivers) once again by means of double differentiation.

This technique permits real-time estimation of the displacements of the receiver close to the epicentre with an accuracy with centimetre order of magnitude only if the two receivers involved are not more than a few hundred kilometres apart. Thus, this implies that this determination of displacements in real time can only be achieved if all the aforementioned data are available (phase observations and broadcast or precise ephemerides), for at least two receivers simultaneously. That is, for the displacements to be determined in real time, the phase observations of at least two receivers must be acquired and processed by a control centre, and therefore, overall, this technique requires the existence, and functionality in real time, of a complex infrastructure (network of permanent stations). An example of this differential approach is described in: Y. Bock et al., Modeling and On-the-Fly Solutions for Solid Earth Sciences: Web Services and Data Portal for Earthquake Early Warning System, IGARSS 2008; and another example is given in Y. Feng, B. Li, 4D Real Time Kinematic Positioning, FIG Congress 2010.

A second method, also based on signals acquired (phase observations) by dual-frequency receivers of the geodetic class, is that of precision absolute positioning by means of phase observations (Precise Point Positioning, PPP). This method makes it possible to estimate the displacements of a single receiver using values published by international scientific institutions (e.g. International GNSS Service (IGS)) of the precise ephemerides of the satellites, of the clock errors of said satellites and of other parameters useful for eliminating the disturbances caused by the physical effects mentioned above.

Theoretically, this method makes it possible to obtain results with a precision with centimetre order of magnitude and a variable latency relative to the timepoint to which the phase observations acquired by the receiver relate. This period of latency is between one day and two weeks. Thus, on one hand the PPP method does not require the availability of observations coming from receivers other than that involved, but on the other hand it cannot be used in real time but only a posteriori (off-line) or only on the aforementioned precise data becoming available (precise ephemerides, clock errors of the satellites themselves and other parameters useful for eliminating the disturbances caused by the physical effects mentioned above). This method too can be applied involving more than one receiver, i.e. implying the existence of a network of permanent stations. In this case, the advantage of the PPP method compared with the double-difference method is that it does not impose a limit on the distance between the receivers. An example of application of the PPP method to a network of permanent stations is mentioned in: [3] G. Blewitt et al., GPS for Real-Time Earthquake Source Determination and Tsunami Warning Systems, 2009, which identifies the requirements of a system based on a network of permanent stations that could guarantee real-time determination of coseismic displacements but which, at present, has problems that are still unresolved, in particular relating to the availability in real time of precise data: precise ephemerides, precise clock errors and other parameters useful for eliminating the effects mentioned above. K. Larson et al., Using 1-Hz GPS Data to Measure Deformations caused by the Denali Fault Earthquake, Science, 2003 demonstrates the potentialities and advantages of GPS in determination of coseismic displacements, without explicitly mentioning the method used; in any case, the distances between the GPS stations considered appear to be incompatible with the double-difference method and therefore it can be presumed that the PPP method is used with precise data available off-line; in this connection, in this document there is no mention of the possibility of obtaining measurements in real time.

Thus, even when the use of the PPP method with one or more receivers is proposed, the impossibility of having precise corrective data available in real time (precise ephemerides of the satellites, clock errors of said satellites and other parameters useful for eliminating the disturbances caused by the physical effects mentioned above) does not provide estimates of coseismic movements or of structures of the order of a centimetre in real time.

### SUMMARY OF THE INVENTION

The purpose of the present invention is to provide a method for measuring movements, in particular coseismic movements or vibrations of structures, with a precision having a centimetre order of magnitude, able to operate both in real time and a posteriori by means of a single receiver able to perform phase observations on signals according to at least one frequency from at least one GNSS constellation and/or pseudolites and effect calculation corrections using broadcast corrective data by radio.

The present invention relates to a system for measuring coseismic movements or vibrations of structures based on Global Navigation Satellite Systems-GNSS and/or pseudolites, according to Claim 1.

A receiver able to perform phase observations on at least one frequency from at least one GNSS constellation and/or pseudolites is briefly referred to hereinafter as “GNSS receiver”.

The fundamental concept that differentiates the method of calculation of the present invention from the prior art resides in the fact that a variometric phase equation is calculated for couples of consecutive observations at frequency greater than or equal to 1 Hz, received by one and the same source, and this operation is repeated for at least four sources simultaneously in order to obtain a system of four equations in four unknowns. One unknown of the four unknowns is determined by corrective data broadcast by radio in order to obtain a closed system. In fact the other three unknowns are determined by solving the system and determining a displacement that has occurred during the time interval defined by said couple of successive observations.

Advantageously, this makes it possible to use imprecise corrective data broadcast by radio and available in real time and obtain real-time measurements of the displacements of the order of a centimetre using a single receiver.

A further aim of the invention is to provide a device for measuring coseismic movements or vibrations of structures based on Global Navigation Satellite Systems-GNSS and/or pseudolites, which is able to solve the aforementioned problem.

The present invention also relates to a system for measuring coseismic movements or vibrations of structures based on Global Navigation Satellite Systems-GNSS, according to Claim 9.

Advantageously, the present invention makes it possible to determine, both in real time and in off-line mode, and with just one GNSS receiver, with accuracy of the order of a centimetre, coseismic displacements due to earthquakes and vibrations of structures. Determination, especially in real time, of these quantities permits timely detection of displacements due to earthquakes that can trigger catastrophic events such as tsunami and therefore represents fundamental information for warning and alerting the population. Moreover, the invention makes it possible to determine the seismic moment and the magnitude, avoiding the problems of saturation commonly present in seismometers positioned near the epicentres of large seismic events.

Advantageously, the present invention, relative to the prior art, makes it possible to determine coseismic displacements both in real time and off-line using just one receiver and corrective data (broadcast).

Moreover, the present invention also finds application in the determination, in real time and off-line, of the extent of the displacements associated with the modes of vibration of large structures such as bridges, towers, skyscrapers, etc., with a precision with centimetre order of magnitude.

The claims describe preferred embodiments of the invention, forming an integral part of the present description.

### BRIEF DESCRIPTION OF THE DRAWINGS

Further characteristics and advantages of the invention will become clearer from the detailed description of preferred, but not exclusive, embodiments of a method of carrying out the invention, illustrated as a non-limiting example with the aid of the accompanying drawings, in which:

FIG. 1 shows a preferred flow diagram of the method according to the present invention.

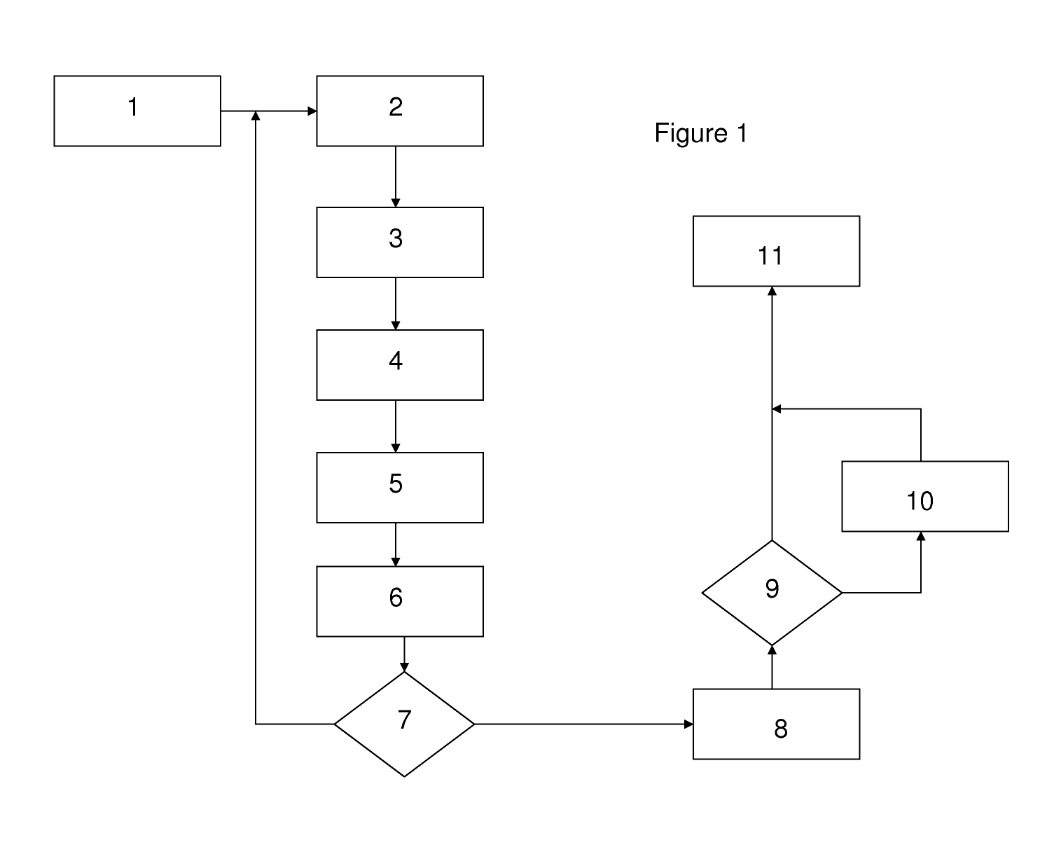

The same reference numbers and letters in the drawings identify the same elements or components.

### DETAILED DESCRIPTION OF A PREFERRED EMBODIMENT OF THE INVENTION

The method, envisaging the use of just one GNSS receiver, can advantageously be implemented in the firmware thereof, which can then provide in real time, but also a posteriori (off-line), measurements of displacements with a precision of centimetre order of magnitude and yet depending on the number of frequencies and on the number of constellations tracked and without the need for further processing.

The method of the present invention is preferably implemented by a GNSS receiver comprising means for reception and for phase observations with sampling frequency of 1 Hz or higher, means for processing the aforementioned phase observations and storage means capable of storing:
reference coordinates of a position of the receiver,
corrective data broadcast by radio, including ephemerides, clock corrections and broadcast ionospheric model preferably received from the same GNSS satellites in real time, by the same receiving means, simultaneously with reception of the phase observations
results of processing,

The method comprises the following basic steps:
reception of a GNSS phase observation from at least four satellites in view,
expression of a phase difference in time by an equation of the type (called variometric equation of phase)

[λΔΦ^{s}ᵣ]=(e^{s}ᵣ·Δξᵣ+cΔδtᵣ)+([Δρ^{s}ᵣ]_{OR}−cΔδt^{s})+Δε^{s}ᵣ (1)

of at least one couple of signals received at consecutive timepoints (t, t+1) from one and the same source and for each source, i.e. one of said at least four satellites and/or pseudolites, where
[λΔΦ^{s}ᵣ] is the phase difference in time, or the difference of the GNSS phase observations acquired in two consecutive periods of measurement on the general frequency or on a combination of frequencies,
(e^{s}ᵣ·Δξᵣ+cΔδtᵣ) is the term containing the four unknown parameters, i.e. the displacements Δξᵣ in three dimensions and the variations of the clock error Δδtᵣ,
([Δρ^{s}ᵣ]_{OR}−cΔδt^{s}) is the known term calculated on the basis of information available for the ephemerides and for the synchronization errors of the GNSS satellites tracked (this information is available in real time in the navigation message)
Δε^{s}ᵣ is the electronic noise;
calculation of a weighting using an expression
w=cos²(Z) for each variometric equation, where
Z is the zenith angle of the satellite relative to the receiver;
solution of the system of at least four equations in four unknowns with respect to Δξᵣ, of which three unknowns represent a three-dimensional displacement of the receiver and a fourth unknown relates to the variation of the clock error; in this way, any displacement that occurred in the time interval, defined by said couple of consecutive timepoints and less than or equal to 1 s, is determined, and the three-dimensional displacements calculated for another couple of consecutive timepoints (t, t+1) are summed, for the purpose of reconstructing the course of the displacements of the receiver in an allotted time interval comprising said couples of timepoints.

The corrective data can be transmitted from many alternative sources, for example from said GNSS (s) satellites and/or pseudolites, so as to be received in real time, with the same GNSS antenna and simultaneously with the signals required for determination of the phase observations.

The accuracy of the result can be improved by inserting further additional terms in the variometric equation, modelling effects/disturbances that may occur:
(ΔT^{s}ᵣ−ΔI^{s}ᵣ) can take account of effects of atmospheric propagation, which are modelled or eliminated by a suitable combination of frequencies
([Δρ^{s}ᵣ]_{EtOI}+Δp^{s}ᵣ) can take account of effects of terrestrial and ocean tides and relativistic effects,
Δm^{s}ᵣ is the multipath of the signals transmitted

arriving at the following formulation

[λΔΦ^{s}ᵣ]=(e^{s}ᵣ·Δξᵣ+cΔδtᵣ)+([Δρ^{s}ᵣ]_{OR}−cΔδt^{s})+(ΔT^{s}ᵣ−ΔI^{s}ᵣ)+([Δρ^{s}ᵣ]_{EtOI}Δp^{s}ᵣ)+Δm^{s}ᵣ+Δε^{s}ᵣ (2)

This formulation (2) can be obtained directly starting from the general formulation of the phase observation equation.

A further step can be performed for removing the effect of any systematic errors, which appear to be negligible relative to the precision achievable in calculation of the displacement Δξᵣ that may have occurred between said couple of consecutive timepoints but accumulate with a significant effect in the sum of the three-dimensional displacements.

We may advantageously consider the known general formulation of the phase observation equation, for example, of Hoffman-Wellenhof et al. (2008), written in units of length:

λΦ^{s}ᵣ=ρ^{s}ᵣ+c(δtᵣ−δt^{s})+T^{s}ᵣ−I^{s}ᵣ−λN^{s}ᵣ+p^{s}ᵣ+m^{s}ᵣ+ε^{s}ᵣ (a)

where: Φ^{s}ᵣ is the phase observation of the receiver r relative to the satellite s; λ is the wavelength of the phase; ρ^{s}ᵣ is the geometric distance between the satellite s and the receiver r; c is the speed of light; δtᵣ and δt^{s} are the clock errors of the receiver r and of the satellite s; T^{s} ᵣ and I^{s}ᵣ are the tropospheric and ionospheric delays along the path from the satellite s to the receiver r; N^{s}ᵣ is the initial phase ambiguity; p^{s}ᵣ is the sum of other effects (relativistic effects, variation of the centre of phase, phase wind up), m^{s}ᵣ and ε^{s}ᵣ are the multipath effect and the error.

According to the present invention, a single difference is calculated in the time between two consecutive timepoints (t, t+1) of phase observation as described by equation (a). Assuming that phase observations at high frequency are used, i.e. at frequency greater than or equal to 1 Hz, a second expression of said phase difference equation is obtained:

λΔΦ^{s}ᵣ(t, t+1)=Δρ^{s}ᵣ(t, t+1)+c(Δδtᵣ(t, t+1)−Δδt^{s}(t, t+1))+ΔT^{s}ᵣ(t, t+1)−ΔI^{s}ᵣ(t, t+1)+Δp^{s}ᵣ(t, t+1)+Δm^{s}ᵣ(t, t+1)+Δε^{s}ᵣ(t, t+1) (b)

It is preferred for the position of the receiver to be fixed in an ECEF (Earth Centred Earth Fixed) reference system; then the first term Δρ^{s}ᵣ (t, t+1) on the right-hand side of the difference equation (b) depends only on the variation of the distance between the satellite and the receiver, determined both by the orbital motion of the satellite and by the rotation of the Earth, apart from the much smaller effects of the terrestrial tides and the ocean loading. Said first term is put equal to

Δρ^{s}ᵣ(t, t+1)=([Δρ(t, t+1)^{s}ᵣ]_{OR}+([Δρ(t, t+1)^{s}ᵣ]_{EtOI}

When the receiver undergoes a displacement Δξᵣ(t, t+1) relative to an ECEF reference system between two consecutive timepoints (t, t+1), then said first term Δρ^{s}ᵣ(t, t+1) also includes the effect of the displacement Δξᵣ(t, t+1) projected along the line of sight between the satellite s and the receiver r, which is assumed to have remained constant between said two consecutive timepoints, therefore said first term is put equal to

Δρ^{s}ᵣ(t, t+1)=([Δρ(t, t+1)^{s}ᵣ]_{OR}+([Δρ(t, t+1)^{s}ᵣ]_{EtOI}+[Δρ^{s}ᵣ(t, t+1)]=([Δρ(t, t+1)^{s}ᵣ]_{OR}+([Δρ(t, t+1)^{s}ᵣ]_{EtOI}+e^{s}ᵣ·Δξᵣ(t, t+1) (c)

where e^{s}ᵣ is the versor between the satellite s to the receiver r and the symbol · indicates the scalar product between the versor e^{s}ᵣ and Δξᵣ(t, t+1).

Substituting this second expression of the first term in the right-hand side, in the difference equation (b), and omitting, for the moment, the reference to the time period, a variometric equation is obtained:

λΔΦ^{s}ᵣ=[Δρ^{s}ᵣ]_{OR}+e^{s}ᵣ·Δξᵣ+c(Δδt−Δδt^{s})+Δε^{s}ᵣ (d)

Particular attention will now be paid to the terms [Δρ^{s}ᵣ]_{OR} and Δδt^{s}: in the present state, since, according to the present invention, couples of consecutive timepoints are considered that are not more distant, temporally, than 1 second, for calculating the terms [Δρ^{s}ᵣ]_{OR} and Δδt^{s} it is possible to use the broadcast ephemerides and the clock errors acquired in real time from the GNSS receiver, obtaining errors smaller than a millimetre. In particular, these data represent Keplerian orbit parameters necessary for calculating the positions of the satellites at each timepoint and coefficients of the parabolic model of drift of the errors of synchronism of the clocks of the satellite, from the moment that these show a minimum drift with respect to said products of a precise type.

This variometric equation therefore assumes the following preferred form, which coincides with (2):

λΔΦ^{s}ᵣ=(e^{s}ᵣ·Δξᵣ+cΔδtᵣ)+([Δρ^{s}ᵣ]_{OR}−cΔδt^{s})+(ΔT^{s}ᵣ−ΔI^{s}ᵣ)+([Δρ^{s}ᵣ]_{EtOI}+Δp^{s}ᵣ)+Δm^{s}ᵣ+Δε^{s}ᵣ (e)

where λΔΦ^{s}ᵣ is the difference of the observations, (e^{s}ᵣ·Δξᵣ+cΔδtᵣ) is the term containing the 4 unknown parameters, i.e. a displacement in a three-dimensional ECEF system Δξᵣ that defines three unknowns and the variation of the clock error ([Δρ^{s}ᵣ]_{OR-cΔδt}^{s})+(ΔT^{s}ᵣ−ΔI^{s}ᵣ)+([Δρ^{s}ᵣ]_{EtOI}+Δp^{s}ᵣ) is the known term calculated on the basis of the transmitted ephemerides and suitable models, Δm^{s}ᵣ is the multipath and Δε^{s}ᵣ is the noise.

The variometric equation in the preferred form (e) represents a functional model for use in a least-squares estimate for determining the displacements of the receiver for each couple of consecutive timepoints.

It is known that observations coming from satellites with a low angle of elevation are noisier, for this reason the stochastic model for the method of estimation envisages the application of a weighting for the observations w(λΔΦ^{s}ᵣ) equal to the cosine squared of the zenith angle Z of the satellite relative to the receiver

w=cos²(Z) (f)

where Z is the zenith angle of the satellite relative to the receiver.

The least-squares estimate is based on a set of systems of variometric equations that can be written for two general consecutive timepoints; their number depends on the availability of satellites and/or pseudolites during said two consecutive timepoints.

For the purpose of increasing the number of phase observations, it is preferable for the receiver to be able to receive signals on several frequencies and from several constellations, thus being able to receive a larger number of phase observations simultaneously. Moreover, the availability of phase observations on several frequencies makes it possible to eliminate the ionospheric effect ΔI^{s}ᵣ by means of a suitable linear combination of the variometric equations relating to different frequencies (ionospheric-free combination).

To detect the displacements of the receiver, the displacements estimated by means of said preferred variometric equation (e) during a specified time interval are summed.

The error with which it is possible to calculate the known term ([Δρ^{s}ᵣ]_{OR}−cΔδr^{s})+(ΔT^{s}ᵣ−ΔI^{s}ᵣ)+([Δρ^{s}ᵣ]_{EtOI}+Δp^{s}ᵣ) is small for a single couple of consecutive timepoints but tends to become significant if summed over time for a plurality of successive time couples; then the time series of the cumulative displacements ΣΔξᵣ shows a low-frequency component (trend). Preferably, the present method comprises a step of elimination of said trend directly from the time series of the displacements Δξᵣ by considering a suitable interval prior to that of the event that is to be described kinematically (seismic event, structural vibration, etc.) and using a low-grade polynomial interpolation, for example to the second;

preferably, this polynomial interpolation should be performed using a robust estimator, for example, of the so-called Least Trimmed Squares type of Rousseew.

A preferred embodiment of the method of determination of the displacements in real time, but also off-line, is based on a GNSS receiver able to acquire phase observations on at least one frequency from at least one GNSS constellation. Said GNSS receiver, whose position must be known with accuracy of a few metres in the international reference WGS84 system (obtainable very easily by any GNSS receiver), acquires at least the following data:
phase observations on a frequency with sampling interval of 1 second or less from a GNSS constellation,
a navigation message containing at least the broadcast ephemerides and the clock corrections of the GNSS constellation(s) observed.

The calculation model preferred according to the present invention is therefore based on said variometric equation and said weighting factor of the observations defining a stochastic model:

λΔΦ^{s}ᵣ=(e^{s}ᵣ·Δξᵣ+cΔδtᵣ)+([Δρ^{s}ᵣ]_{OR}−cΔδt^{s})+(ΔT^{s}ᵣ−ΔI^{s}ᵣ)+([Δρ^{s}ᵣ]EtOI+Δp^{s}ᵣ)+Δm^{s}ᵣ+Δε^{s}ᵣ

w=cos²(Z)

The displacements are determined by means of a least-squares estimate of variations of coordinates obtained, by application of the aforementioned variometric equation according to the aforementioned stochastic model.

Obviously the performance of the method depends on the number of frequencies and on the number of constellations that the GNSS receiver is able to track, as these characteristics determine the number and possible combinations of variometric equations that can be written.

Starting from these three input data, i.e. phase observations, navigation message and position in the WGS84 system, which are available while it is operating, the method according to the present invention comprises the following steps, preferably implemented in the firmware of a GNSS receiver:
step 1, definition of a global time interval of calculation of the total displacements constituted of two partial intervals:
   an interval (Δtₐ) preceding that in which the event is manifested that is to be described kinematically (seismic event, structural vibration, etc.), having a duration of at least 1 minute
   the interval (Δtₑ) in which said event is manifested; for example, for an earthquake it is an interval, generally of 1-3 minutes, during which the seismic phenomenon is manifested;
step 2, during said time interval, calculation of the differences between phase observations relating to at least four satellites at a couple of consecutive timepoints, each couple of timepoints defining an interval less than or equal to 1 second;
step 3, calculation of the term [([Δρ^{s}ᵣ]_{OR}−cΔδt^{s})+(ΔT^{s}ᵣ−ΔI^{s}ᵣ)+([Δρ^{s}ᵣ]_{EtOI}+Δp^{s}ᵣ)] in the right-hand side of the variometric equation relating to each couple of consecutive timepoints (t, t+1) by means of variations of the phase observations relating to each constellation, at each satellite and for each frequency in two identical consecutive timepoints on the basis of the respective ephemerides of the satellite, of the position of the receiver and of the clock corrections of the satellite and/or of suitable factors that influence the calculation, such as, for example;
step 4, calculation of the versor of the mean receiver-satellite direction for each couple of consecutive timepoints (t, t+1) for calculating the coefficients [e^{s}r] of the unknowns of displacement in the right-hand side of the variometric equation;
step 5, calculation of a weighting factor for each variometric equation λΔΦ^{s}r (t, t+1) for each couple of consecutive timepoints (t, t+1) for each satellite,

w=cos²(Z)

on the basis of the versor of the mean receiver-satellite direction at said two consecutive timepoints (step 3)
step 6, least-squares estimate, for each couple of consecutive timepoints (t, t+1), of the three displacement unknowns Δξᵣ and of the unknown relating to the variation of clock error Δδtr and of their precision;
step 7, verification that the calculation interval defined in step 1 is not completed; if it is not completed, it resumes from step 2, i.e. from calculation of the phase observations relating to at least four satellites at a couple of consecutive timepoints, otherwise
step 8, sum of the displacements Δξᵣ estimated by least squares on the whole calculation interval defined in point 1
step 9, if the time series of the cumulative displacements ΣΔξ relating to the calculation time interval (Δtₐ), defined in step 1, shows a low-frequency component (trend) then
step 10, elimination of said trend on the whole global calculation interval, as in step 1, using a low-grade polynomial interpolation, otherwise if (step 9) no low-frequency component is identified,
step 11 calculation of the total displacements, therefore available at the end of the prearranged calculation interval.

Said calculation, step 2, of the differences between phase observations relating to at least four sources (satellites and/or pseudolites) at a couple of consecutive timepoints is performed for each couple of consecutive timepoints of said total calculation interval, defined in step 1, for each constellation, for each satellite and for each frequency observed, for the purpose of calculating the left-hand side of the variometric equation [λΔΦ^{s}r (t, t+1)]; if, however, in the interval between said consecutive timepoints a so-called cycle slip occurs between a satellite and the receiver, i.e. an event that causes an interruption of the measurement, then the variometric equation relating to that satellite, that frequency and that couple of consecutive timepoints is not taken into account, i.e. is discarded.

If, at a certain timepoint, at least four satellites are not available simultaneously, then the method starts again from step 2.

The elements and the characteristics illustrated in the various preferred embodiments can be combined while remaining within the scope of protection of the present patent application.

The method of determination of the displacements in real time according to the variometric approach presented above can also be applied using:
observations from all the GNSS constellations currently in operation and from those in the phase of realization and/or from pseudolites
one or more frequencies (also in suitable combinations thereof) made available by all the GNSS constellations currently in operation and from those in the phase of realization
various types of GNSS receivers
information relating to the broadcast ionospheric model, directly available within the broadcast corrective data, or of ionospheric models available in a network, for improving the precision of the algorithm
signals generated by pseudolites, in addition to or replacing those coming from one or more GNSS constellations currently in operation and from those in the phase of realization

Moreover, the method of determination of displacements according to the variometric approach can also be applied in off-line mode (i.e. not in real time) either with broadcast corrective data and precise data (precise ephemerides and clock errors of the satellites, etc.). However, implementation with broadcast corrective data is preferred, in order to be able to perform measurements of the order of a centimetre in real time.

The functionality and effectiveness of the method of determination of displacements according to the method described here has been validated by experimental results obtained, firstly, in off-line mode with broadcast corrective data and GPS phase observations acquired from permanent stations affected by significant seismic events. The same results were also compared with excellent agreement (centimetre order of magnitude) with those obtained by the methods of the prior art capable of obtaining the same or greater accuracy of the measurements. Finally, the method has also been validated successfully in real time.

1. A method of measurement of coseismic movements or of vibrations of structures with centimetre precision, in real time, based on Global Navigation Satellite Systems-GNSS by means of a receiver (r) comprising receiving means and means for GNSS phase observations at sampling frequency of 1 Hz or higher and means for receiving corrective data broadcast by radio, means for processing the aforesaid observations and means for storage in which the following information is stored:
reference coordinates of a position of the receiver, receiver;
corrective data broadcast by radio in real time, including at least ephemerides, clock corrections and ionospheric model model; and
results of processing;
the method comprising the following steps:
reception and determination of GNSS couple phase observations from at least four GNSS sources and reception of corrective data broadcast by radio in real time;
calculation of a phase difference in time for one couple of said phase observations received at consecutive timepoints (t, t+1) at said sampling frequency of 1 Hz or higher, each couple of phase observations coming from each of said GNSS sources;
expression of each said phase difference in time by means of a variometric phase equation, in order to define a system of at least four variometric equations of phase, each for each couple of phase observations and including four unknown quantities defining:
three Cartesian components of a three-dimensional displacement occurring between said consecutive timepoints (t, t+1); and
a variation of clock error of the receiver occurring between said consecutive timepoints (t, t+1);
calculation of a weighting factor of each variometric phase equation, equation; and
solving, by means of a least-squares estimate, said system of at least four variometric equations of phase with respect to said respective four unknown quantities.

2. The method according to claim 1, wherein at least said at least four GNSS sources belong to one or more:
satellites of one or more constellations of satellites; or
pseudolites.

3. The method according to claim 2, wherein when at least one signal source is a pseudolite, it further comprises the step of acquiring a position of said pseudolite and a related clock correction datum.

4. The method of measurement according to claim 1, wherein said variometric phase equation is obtained from a general equation of phase observation having the expression
λΔΦ^{s}ᵣ=(e^{s}ᵣ·Δξᵣ+cΔδtᵣ)+([Δρ^{s}ᵣ]_{OR}−cΔδt^{s})+Δε^{s}ᵣ (· scalar product)
where:
s relates to one of the at least four GNSS sources and r to a receiver;
λΔΦ^{s} is a phase difference between phase observations received at consecutive timepoints (t, t+1) at a sampling frequency of 1 Hz or higher;
(e^{s}ᵣ·Δξᵣ+cΔδtᵣ) comprises said four unknowns, of which three (Δξᵣ) relate to said three-dimensional displacement occurring between the consecutive timepoints (t, t+1) and one (Δδtᵣ) relates to said variation of clock error of the receiver occurring between the consecutive timepoints (t, t+1);
([Δρ^{s}ᵣ]_{OR-cΔδt}^{s}) is a known term calculated by means of said corrective data received via radio; and
Δε^{s}ᵣ is a noise component.

5. The method of measurement according to claim 1, wherein said variometric phase equation is of the type
λΔΦ^{s}ᵣ=(e^{s}ᵣ·Δξᵣ+cΔδtᵣ)−([Δρ^{s}ᵣ]_{OR}−cΔδt^{s})+(ΔT^{s}ᵣ−ΔI^{s}ᵣ)+([Δρ^{s}ᵣ]_{EtOi}+Δp^{s}ᵣ)+Δm^{s}ᵣ+Δε^{s}ᵣ,
where:
(ΔT^{s}ᵣ−ΔI^{s}ᵣ) defines a variation of an effect of atmospheric refraction occurring between consecutive timepoints (t, t+1) and calculated by means of said corrective data; and
([Δρ^{s}ᵣ]_{EtOi}+Δp^{s}ᵣ) defines a variation of effects of solid Earth tide, of ocean tide and relativistic effects between consecutive timepoints (t, t+1) and calculated by means of said corrective data.

6. The method of measurement according to claim 1, wherein said weighting of each variometric phase equation is calculated from the following equation
w=cos²(Z)
where Z is the angle between the zenith of the receiver r and one of said at least four satellites s;
said weighting is assumed equal to 1 when a variometric equation of phase is calculated on a signal received from one pseudolite.

7. The method of measurement according to claim 4, wherein said three-dimensional displacement Δξᵣ is summed with itself on a closed time interval comprising a plurality of said couples of consecutive timepoints (t, t+1), for calculating a displacement of the receiver r during said closed time interval.

8. Method The method of measurement according to claim 1, further comprising a step of eliminating a systematic error, having a non-zero average.

9. The method according to claim 7, wherein said systematic error is detected on a closed time interval of a few minutes.

10. A device for real-time measurement of coseismic movements or of vibrations of structures, comprising means for carrying out the method according to claim 1.

11. The device according to claim 8, wherein said GNSS receiver is of dual frequency and is able to carry out the aforementioned method on signals received from both frequencies.

12. (canceled)

13. (canceled)
